(19) United States
(12) Patent Application Publication
(10) Pub. No.: US 2026/0045887 A1
(43) Pub. Date: Feb. 12, 2026

(54) POWER CONVERTER

(71) Applicant: DENSO CORPORATION, Kariya-city (JP)

(72) Inventors: Renshiro Fukuhara, Nisshin-city (JP); Yuki Tsutsu, Kariya-city (JP); Yuichi Handa, Kariya-city (JP)

(73) Assignee: DENSO CORPORATION, Kariya-city (JP)

(21) Appl. No.: 19/364,551

(22) Filed: Oct. 21, 2025

Related U.S. Application Data
(63) Continuation of application No. PCT/JP2024/015929, filed on Apr. 23, 2024.

(30) Foreign Application Priority Data
May 18, 2023 (JP) 2023-082462

(51) Int. Cl. H02M 3/335; B60L 53/62; H02M 1/00

(52) U.S. Cl. CPC H02M 3/33584; B60L 53/62; H02M 1/007; B60L 2210/10; B60L 2210/30

(57) ABSTRACT

A power converter includes a transformer and bridge circuits. The transformer includes a plurality of coils magnetically coupled with each other. The bridge circuits are provided one for each of the coils. The power converter works to achieve bidirectional transfer of power between the bridge circuits through the transformer. The bridge circuits include a main bridge circuit and sub-bridge circuits. The main bridge circuit has the highest rated power among the bridge circuits. The power converter also includes a main connection path and sub-connection paths. The main connection path connects the main bridge circuit and the coil used with the main bridge circuit. The sub-connection paths connect the sub-bridge circuits and the coils used with the sub-bridge circuits. The main connection path has an impedance lower than that of the sub-connection paths.

### CROSS REFERENCE TO RELATED DOCUMENT

The present application claims the benefit of priority of Japanese Patent Application No. 2023-082462 filed on May 18, 2023, the disclosure of which is incorporated in its entirety herein by reference.

### TECHNICAL FIELD

This disclosure relates generally to a power converter including a power transformer equipped with a plurality of magnetically-coupled coils and bridge circuits provided one for each of the coils.

### BACKGROUND ART

Non-Patent Document 1 listed below teaches a multi-port converter in which a plurality of ports each of which is equipped with a bridge circuit are interconnected via a transformer, and bidirectional power transfer is performed between the respective ports. The multi-port converter is designed to have one of the ports which has a low inductance, thereby improving controllability thereof.

### PRIOR ART DOCUMENT

### Non-Patent Document

IEEE Transactions on Power Electronics, (U.S.), February 2021, Vol. 36, No. 2, pp. 2231-2245

### SUMMARY OF THE INVENTION

The above-described structure in which the respective ports are magnetically coupled using the transformer has a risk that power transfer control operations in the ports may interfere with one another, whereby a large current may flow in one of the ports. This may lead to a drawback in that an overcurrent exceeding a rated current may flow through a corresponding one of the bridge circuits.

This disclosure has been made in view of the above-described problems. It is a primary object of this disclosure to provide a power converter capable of suppressing an overcurrent from flowing through bridge circuits.

The first aspect of this disclosure is to provide a power converter which comprises: (a) a transformer which includes a plurality of coils magnetically coupled with each other; and (b) bridge circuits which are provided one for each of the coils and each of which works to switch a polarity of ac voltage applied to a corresponding one of the coils to achieve bidirectional transfer of power between the bridge circuits through the transformer. One of the bridge circuits which has the highest rated power among the bridge circuits is defined as a main bridge circuit. At least one of the bridge circuits other than the main bridge circuit is defined as a sub-bridge circuit. The power converter also comprises a main connection path and a sub-connection path. The main connection path connects the main bridge circuit and one of the coils which is used with the main bridge circuit. The sub-connection path connects the sub-bridge circuit and a corresponding one of the coils. The main connection path has an impedance lower than that of the sub-connection path.

It is conceivable to design the power converter to have a rated power of any one of the bridge circuits made higher than rated powers of the remaining bridge circuits. This structure permits a large current to flow in one of the bridge circuits which has a higher rated power as compared with in the bridge circuits having lower rated powers.

In the above-described first aspect of this disclosure, the main bridge circuit which has the highest rated power in the bridge circuits has an impedance lower than that of the sub-connection path which connects the sub-bridge circuit and one of the coils used with the sub-bridge circuit. This facilitates flow of ac current in the main bridge circuit as compared with the sub-bridge circuit, thereby promoting the flow of current in the main bridge circuit which is larger than that in the sub-bridge circuit, however, it is achieved safely since the rated power of the main bridge circuit is set larger than that of the sub-bridge circuit. Therefore, an electrical current flowing through the main bridge circuit becomes equal to or less than a rated current of the main bridge circuit. On the other hand, as compared with a case in which the impedance of the main connection path is larger than or equal to that of the sub-connection path, the current flowing through the sub-bridge circuit is reduced, which eliminates a risk that an overcurrent may flow through the sub-bridge circuit. This avoids flow of an excessive current through each of the bridge circuits.

The second aspect of this disclosure is to provide a power converter which comprises: (a) a transformer which includes three or more coils magnetically coupled with each other; and (b) bridge circuits which are provided one for each of the coils and each of which works to switch a polarity of ac voltage applied to a corresponding one of the coils to achieve bidirectional transfer of power between the bridge circuits through the transformer. One of the bridge circuits which has the highest rated power among the bridge circuits is defined as a main bridge circuit. One of the bridge circuits other than the main bridge circuit is defined as a sub-bridge circuit. At least one of the sub-bridge circuits which receives power from another of the sub-bridge circuits is defined as a power receiving circuit. At least one of the sub-bridge circuits which transmits power to another of the sub-bridge circuits is defined as a power transmission circuit. The power converter also includes a controller which works to perform switching control of the bridge circuits to meet a first power receiving condition and a second power receiving condition when an amount of power transmitted from the power transmission circuit is larger than an amount of power received by the power receiving circuit, and the main bridge circuit serves as the power receiving circuit. The first power receiving condition is a condition in which a timing of switching to a positive polarity of voltage applied to one of the coils which is used with the main bridge circuit and a timing of switching to a positive polarity of voltage applied to one of the coils which is used with the power receiving circuit are delayed relative to a timing of switching to a positive polarity of voltage applied to one of the coils which is used with the power transmission circuit. The second power receiving condition is a condition in which the timing of switching to the positive polarity of voltage applied to one of the coils which is used with the main bridge circuit is set earlier than the timing of switching to the positive polarity of voltage applied to one of the coils which is used with the power receiving circuit.

When each of the three or more sub-bridge circuits is required to operate as the power receiving circuit or the power transmission circuit, it may cause the power outputted from the power transmission circuit to be higher than the power inputted to the power receiving circuit. In this case, the controller works to control the switching operations of the main bridge circuit, the power receiving circuit, and the power transmission circuit such that the timing of switching to the positive polarity of voltage applied to one of the coils used with the main bridge circuit and the timing of switching to the positive polarity of voltage applied to one of the coils used with the power receiving circuit are delayed relative to the timing of switching to the positive polarity of voltage applied to one of the coils used with the power transmission circuit. This causes the power to be transmitted from the power transmission circuit to the main bridge circuit in a period of time in which the polarities of voltages applied to the coils used with the main bridge circuit and the power transmission circuit are different from each other and also causes the power to be transmitted from the power transmission circuit to the power receiving circuit in a period of time in which the polarities of voltages applied to the coils used with the power receiving circuit and the power transmission circuit are different from each other.

When the timing of switching to the positive polarity of voltage applied to the coil used with the main bridge circuit is delayed relative to the timing of switching to the positive polarity of voltage applied to the coil used with the power receiving circuit, it may cause the power receiving circuit to serve as a power relay to perform the power transfer operation to transfer electrical power between the power transmission circuit and the main bridge circuit. In the power transferring operation, the power receiving circuit receives power from the power transmission circuit and supplies it power to the main bridge circuit. In this case, due to the transfer of excessive power through the power receiving circuit during the power transferring operation, there is a concern that an overcurrent may flow through the power receiving circuit.

The power converter in the second aspect of this disclosure is, therefore, designed to control the switching operations of the bridge circuits to have the timing of switching to the positive polarity of voltage applied to one of the coils which is used with the main bridge circuit is set earlier than the timing of switching to the positive polarity of voltage applied to one of the coils which is used with the power receiving circuit. This prevents the power receiving circuit from performing the power transferring operation, thereby minimizing unnecessary power transfer through the power receiving circuit and also eliminating a risk of flow of overcurrent in the power receiving circuit.

The third aspect of this disclosure is to provide a power converter which comprises: (a) a transformer which includes three or more coils magnetically coupled with each other; and (b) bridge circuits which are provided one for each of the coils and each of which works to switch a polarity of ac voltage applied to a corresponding one of the coils to achieve bidirectional transfer of power between the bridge circuits through the transformer. One of the bridge circuits which has the highest rated power among the bridge circuits is defined as a main bridge circuit. The bridge circuits other than main bridge circuit are defined as sub-bridge circuits. At least one of the sub-bridge circuits which is selected to receive power from another of the sub-bridge circuits is defined as a power receiving circuit. At least one of the sub-bridge circuits which is selected to transmit power to another of the sub-bridge circuits is defined as a power transmission circuit. The power converter also includes a controller which works to perform switching control of the bridge circuits to meet a first power transmission condition and a second power transmission condition when an amount of power received by the power receiving circuit is larger than an amount of power transmitted from the power transmission circuit, and the main bridge circuit serves as the power transmission circuit. The first power transmission condition is a condition in which a timing of switching to a positive polarity of voltage applied to one of the coils which is used with the main bridge circuit and a timing of switching to a positive polarity of voltage applied to one of the coils which is used with the power transmission circuit are advanced relative to a timing of switching to a positive polarity of voltage applied to one of the coils which is used with the power receiving circuit. The second power transmission condition is a condition in which the timing of switching to the positive polarity of voltage applied to one of the coils which is used with the main bridge circuit is set after the timing at which voltage applied to one of the coils which is used with the power transmission circuit is switched to the positive polarity.

When each of the three or more sub-bridge circuits is required to operate as the power receiving circuit or the power transmission circuit, it may cause the power received by the power receiving circuit to be larger than that transmitted from the power transmission circuit. In this case, the controller works to control the switching operations of the main bridge circuit, the power receiving circuit, and the power transmission circuit such that the timing of switching to the positive polarity of voltage applied to one of the coils used with the main bridge circuit and the timing of switching to the positive polarity of voltage applied to one of the coils used with the power transmission circuit are advanced relative to the timing of switching to the positive polarity of voltage applied to one of the coils used with the power receiving circuit. This causes the power to be transmitted from the main bridge circuit to the power receiving circuit in a period of time in which the polarities of voltages applied to the coils used with the main bridge circuit and the power receiving circuit are different from each other and also causes the power to be transmitted from the power transmission circuit to the power receiving circuit in a period of time in which the polarities of voltages applied to the coils used with the power receiving circuit and the power transmission circuit are different from each other.

When the timing of switching to the positive polarity of voltage applied to the coil used with the main bridge circuit is earlier than the timing of switching to the positive polarity of voltage applied to the coil used with the power transmission circuit, it may cause the power transmission circuit to serve as a power relay to perform the power transfer operation to transfer electrical power between the main bridge circuit and the power receiving circuit. In the power transferring operation, the power transmission circuit receives power from the main bridge circuit and then supplies it power to the power receiving circuit. In this case, due to the transfer of excessive power through the power transmission circuit during the power transferring operation, there is a concern that an overcurrent may flow through the power transmission circuit.

The power converter in the third aspect of this disclosure is, therefore, designed to control the switching operations of the bridge circuits to have the timing of switching to the positive polarity of voltage applied to one of the coils which is used with the main bridge circuit is set after the timing of switching to the positive polarity of voltage applied to one of the coils which is used with the power transmission circuit. This prevents the power transmission circuit from performing the power transferring operation, thereby minimizing unnecessary power transfer through the power transmission circuit and also eliminating a risk of flow of overcurrent in the power transmission circuit.

### BRIEF DESCRIPTION OF THE DRAWINGS

The above-described object, other objects, features, or beneficial advantages in this disclosure will be apparent from the following detailed discussion with reference to the drawings.

### In the Drawings:

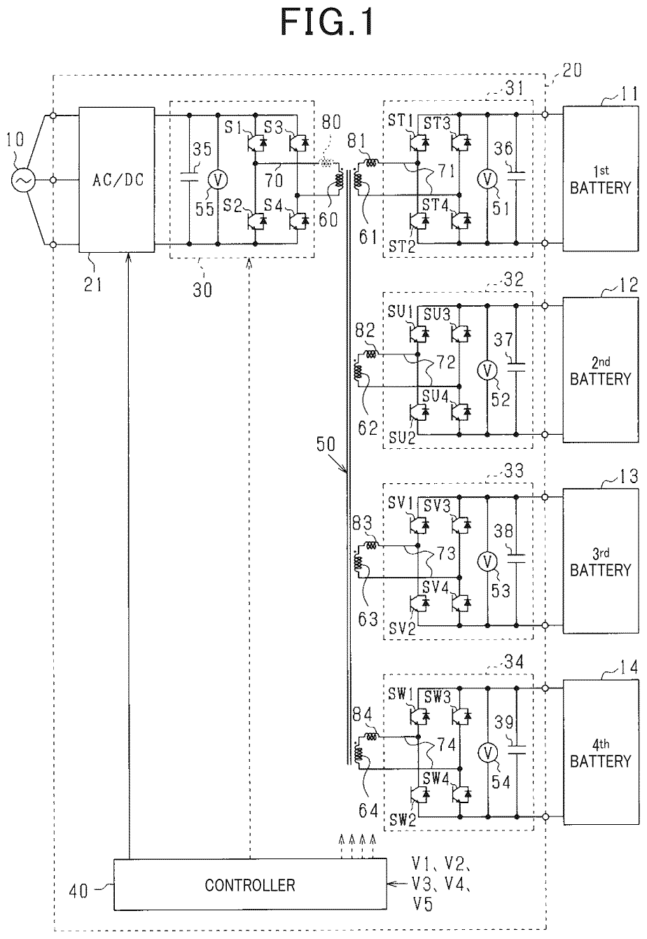

FIG. 1 is a diagram which illustrates an overall configuration of a power supply system according to a first embodiment;

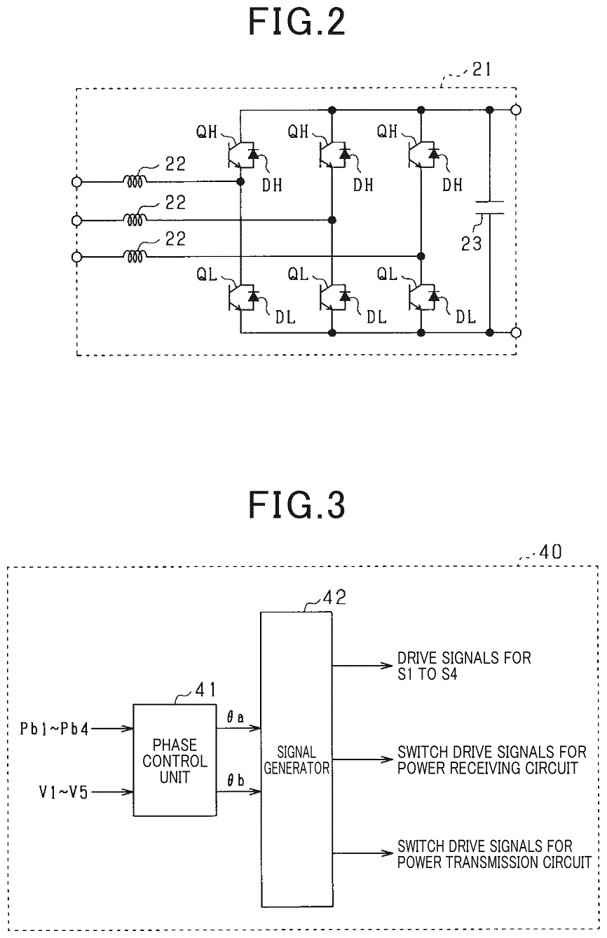

FIG. 2 is a diagram which illustrates an example of an AC-DC converter;

FIG. 3 is a functional block diagram of control performed by a control device;

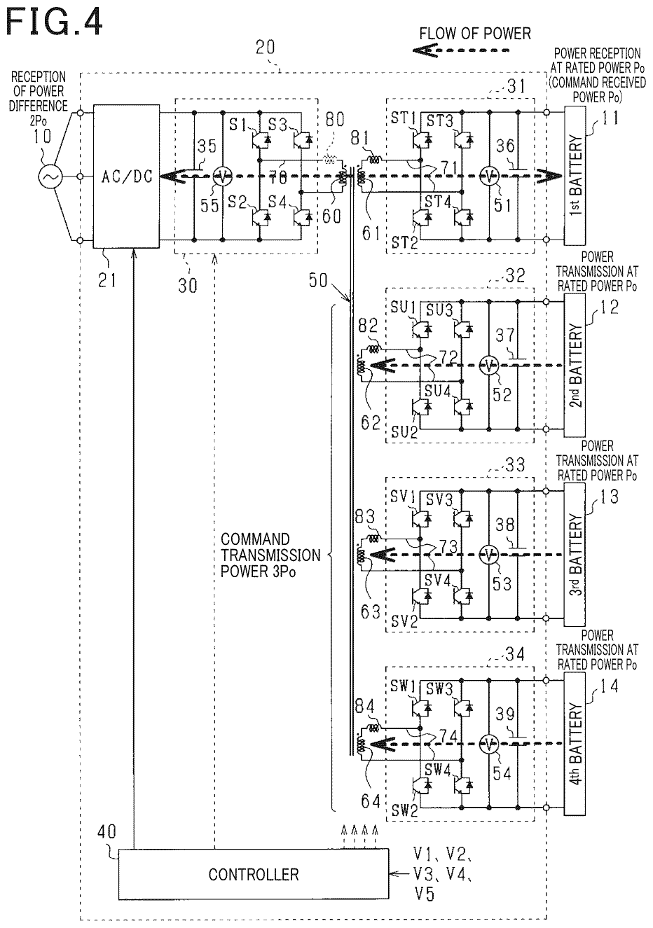

FIG. 4 is a diagram for explaining an operation state of a power converter according to a second embodiment;

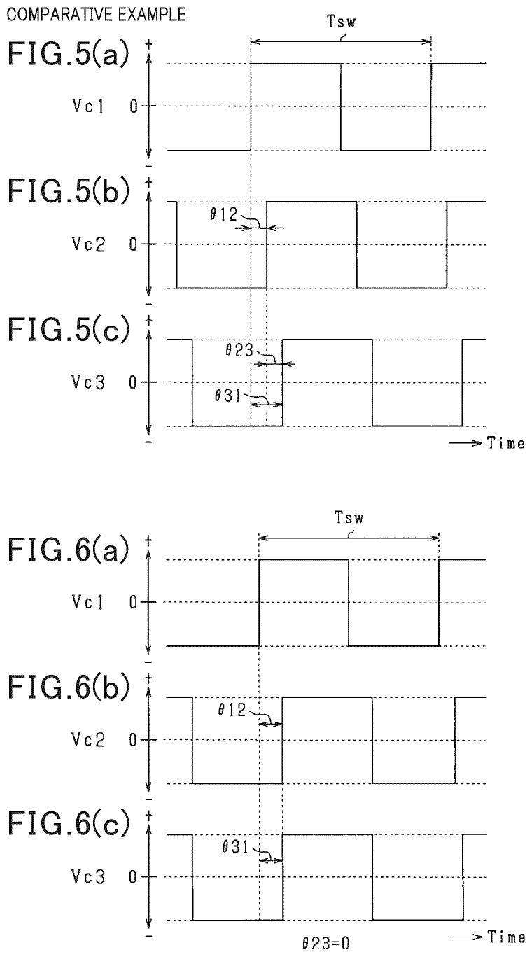

FIGS. 5(a), 5(b), and 5(c) are diagrams which demonstrate controlled operations of switches in a comparative example for explaining a power transferring operation;

FIGS. 6(a), 6(b), and 6(c) are diagrams which demonstrate an example of power transfer control;

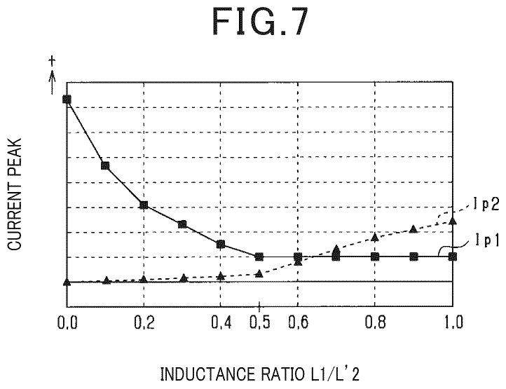

FIG. 7 is a graph which represents an inductance ratio and peak values of currents flowing through bridge circuits;

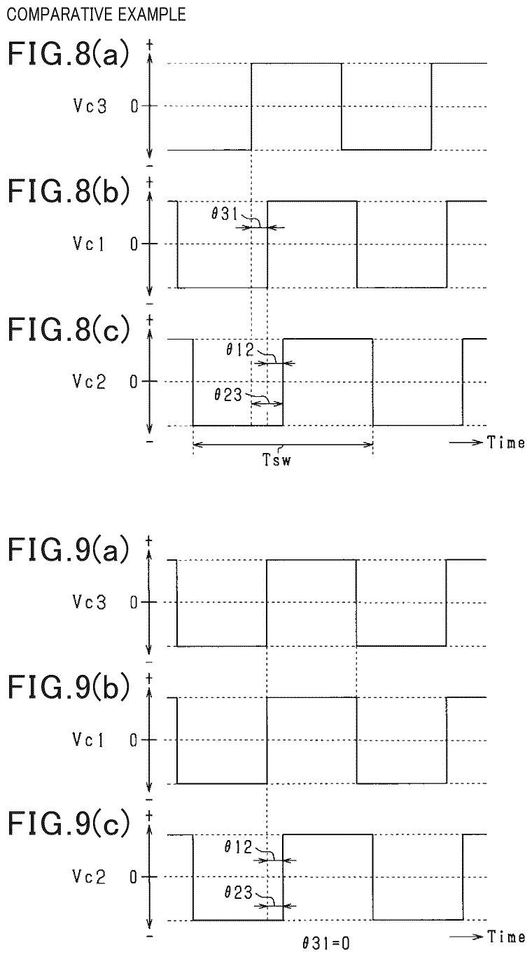

FIGS. 8(a), 8(b), and 8(c) are diagrams which demonstrate controlled operations of switches in a comparative example for explaining power transferring operation;

FIGS. 9(a), 9(b), and 9(c) are diagrams which demonstrate controlled operations of switches in an example of power transfer control; and

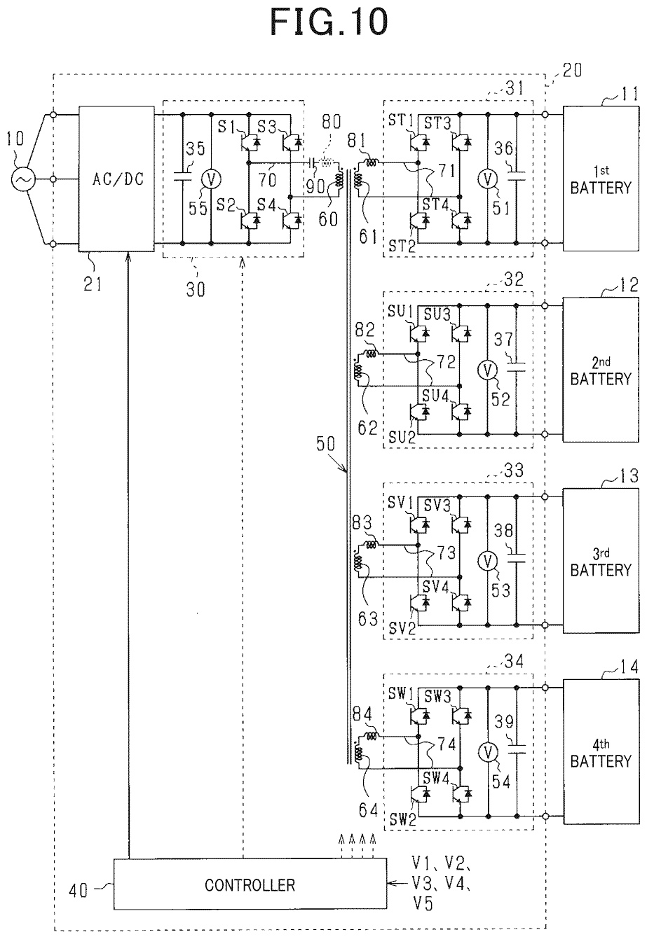

FIG. 10 is a diagram which shows an overall configuration of a power supply system according to another embodiment.

### MODE FOR CARRYING OUT THE INVENTION

### First Embodiment

The first embodiment of a power converter according to this disclosure will be described with reference to the drawings. The power converter of the first embodiment is of a multi-port type, and, for example, is connectable to a power system and a plurality of electrified vehicles, and performs bidirectional power transfer between the power system and batteries mounted in the respective electrified vehicles.

A power supply system, as illustrated in FIG. 1, includes the power system 10, a plurality of batteries, and the power converter 20. The power system 10 is, for example, implemented by a commercial power supply which delivers a three-phase alternating current. The power system 10 is connected to external terminals of the power converter 20. In the example shown in FIG. 1, the plurality of batteries include the first battery 11 to the fourth battery 14. It should be noted that the power system 10 may alternatively be designed as a single-phase commercial power supply.

Each of the batteries 11 to 14 is made of a rechargeable secondary battery, for example, a lithium-ion storage battery. The batteries 11 to 14 are mounted in electrified vehicles, such as, plug-in hybrid electric vehicles (PHEVs) or electric vehicles (EVs), and are, for example, designed as high-voltage batteries serving as driving power sources for the electrified vehicles. It should be noted that the batteries 11 to 14 are not limited to the high-voltage batteries, but may also be low-voltage batteries for auxiliary power supply.

The batteries 11 to 14 are connected to external terminals of the power converter 20. Specifically, by a user of a vehicle (for example, a driver) or an operator connecting a connection plug configured by each of the external terminals of the power converter 20 and a charging inlet of the vehicle, a corresponding one of the batteries 11 to 14 mounted on the vehicle is electrically connected to the external terminal of the power converter 20. In this embodiment, the batteries 11 to 14 serve as “energy storage unit.”

The power converter 20, as illustrated in FIG. 1, includes the AC-DC converter 21, the bridge circuits 30 to 34, and the controller 40. The bridge circuit 30 provided for the power system 10 is herein referred to as the main bridge circuit 30. The bridge circuit 31 provided for the first battery 11 is herein referred to as the first sub-bridge circuit 31. The bridge circuit 32 provided for with the second battery 12 is herein referred to as the second sub-bridge circuit 32. The bridge circuit 33 provided for the third battery 13 is herein referred to as the third sub-bridge circuit 33. The bridge circuit 34 provided for the fourth battery 14 is herein referred to as the fourth sub-bridge circuit 34.

The AC-DC converter 21 has an AC terminal connected to the power system 10 through the external terminal of the power converter 20, and also has a DC terminal connected to the main bridge circuit 30. The AC-DC converter 21 is configured to convert AC power supplied from the power system 10 into DC power and supply it to the main bridge circuit 30, and is also configured to convert DC power delivered from the main bridge circuit 30 into AC power and supply it to the power system 10.

The AC-DC converter 21 is, as can be seen in FIG. 2, designed as a three-phase power factor correction (PFC) circuit. The AC-DC converter 21 includes, for each of three phases, a series connection of the upper-arm switch QH and the lower-arm switch QL, and the reactor 22. Each of the switches QH and QL is made of a voltage-controlled semiconductor switching device, and more specifically, implemented by an insulated gate bipolar transistor (IGBT). In this case, a high-potential terminal of each of the switches QH and QL serves as a collector, and a low-potential terminal thereof serves as an emitter. To each of the upper-arm switches QH and each of the lower-arm switches QL, the upper-arm diode DH and the lower-arm diode DL which are freewheeling diodes, are connected in antiparallel.

The collector of each of the three-phase upper-arm switches QH is connected to a positive terminal of the main bridge circuit 30 using a bus bar or the like. The emitter of each of the three-phase lower-arm switches QL is connected to a negative terminal of the main bridge circuit 30 using a bus bar or the like. A junction between the upper-arm switch QH and the lower-arm switch QL of each phase is connected to a first end of a corresponding one of the reactors 22. A second end of each of the reactors 22 is connected to the power system 10 using the external terminal of the power converter 20. In a case where the power converter 20 is connected to a single-phase commercial AC power supply, the AC-DC converter 21 may employ a single-phase PFC circuit.

The AC-DC converter 21 includes the PFC circuit capacitor 23. The PFC circuit capacitor 23 connects the collector of each of the upper-arm switches QH and the emitter of each of the lower-arm switches QL.

The controller 40 is mainly constituted by a microcomputer including a CPU and various memories. The controller 40 works to operate the switches QH and QL in order to improve a power factor by adjusting a phase and a frequency of voltage and electrical current inputted to or outputted from the power system 10.

The main bridge circuit 30 is designed as a full-bridge circuit, and includes the first to fourth switches S1 to S4 and the main capacitor 35. Each of the switches S1 to S4 is a voltage-controlled semiconductor switching device, and more specifically, is an insulated gate bipolar transistor (IGBT). In this case, a high-potential terminal of each of the switches S1 to S4 serves as a collector, and a low-potential terminal thereof serves as an emitter. To each of the switches S1 to S4, a freewheeling diode is connected in antiparallel.

In the main bridge circuit 30, the collectors of the first switch S1 and the third switch S3 are connected to the positive terminal of the AC-DC converter 21. The emitters of the second switch S2 and the fourth switch S4 are connected to the negative terminal of the AC-DC converter 21. The emitter of the first switch S1 is connected to the collector of the second switch S2, while the emitter of the third switch S3 is connected to the collector of the fourth switch S4. A first end of the main capacitor 35 is connected to the positive terminal of the AC-DC converter 21, and a second end of the main capacitor 35 is connected to the negative terminal of the AC-DC converter 21. The main capacitor 35 may alternatively be arranged outside the main bridge circuit 30.

Each of the sub-bridge circuits 31, 32, 33, and 34 is made of a full-bridge circuit. The sub-bridge circuits 31, 32, 33, and 34 include the first switches ST1, SU1, SV1, and SW1, the second switches ST2, SU2, SV2, and SW2, the third switches ST3, SU3, SV3, and SW3, the fourth switches ST4, SU4, SV4, and SW4, and the sub-capacitors 36, 37, 38, and 39. Each of the switches ST1 to ST4, SU1 to SU4, SV1 to SV4, and SW1 to SW4 is made of a voltage-controlled semiconductor switching device, and more specifically, is an insulated gate bipolar transistor (IGBT). In this case, a high-potential terminal of each of the switches ST1 to ST4, SU1 to SU4, SV1 to SV4, and SW1 to SW4 serves as a collector, and a low-potential terminal thereof serves as an emitter. To each of the switches ST1 to ST4, SU1 to SU4, SV1 to SV4, and SW1 to SW4, a freewheeling diode is connected in antiparallel.

By way of example, in the first sub-bridge circuit 31, the collectors of the first switch ST1 and the third switch ST3 are connected to the positive terminal of the first battery 11. The emitters of the second switch ST2 and the fourth switch ST4 are connected to the negative terminal of the first battery 11. The emitter of the first switch ST1 is connected to the collector of the second switch ST2, and the emitter of the third switch ST3 is connected to the collector of the fourth switch ST4. A first end of the sub-capacitor 36 is connected to the positive terminal of the first battery 11, and a second end of the sub-capacitor 36 is connected to the negative terminal of the first battery 11. The sub-capacitor 36 may alternatively be provided outside the first sub-bridge circuit 31.

It is to be noted that circuit structures of the second to fourth sub-bridge circuits 32 to 34 are the same as that of the first sub-bridge circuit 31. In the second sub-bridge circuit 32, the collectors of the first switch SU1 and the third switch SU3 and a first end of the sub-capacitor 37 are connected to a positive terminal of the second battery 12, and the emitters of the second switch SU2 and the fourth switch SU4 and a second end of the sub-capacitor 37 are connected to the negative terminal of the second battery 12.

In the third sub-bridge circuit 33, the collectors of the first switch SV1 and the third switch SV3 and a first end of the sub-capacitor 38 are connected to the positive terminal of the third battery 13, and the emitters of the second switch SV2 and the fourth switch SV4 and a second end of the sub-capacitor 38 are connected to the negative terminal of the third battery 13. Similarly, in the fourth sub-bridge circuit 34, the collectors of the first switch SW1 and the third switch SW3 and a first end of the sub-capacitor 39 are connected to the positive terminal of the fourth battery 14, and the emitters of the second switch SW2 and the fourth switch SW4 and a second end of the sub-capacitor 39 are connected to the negative terminal of the fourth battery 14.

The power converter 20 includes the transformer 50 having the coils 60 to 64. In FIG. 1, the coil 60 provided for the main bridge circuit 30 is also referred to as the main coil 60, the coil 61 provided for the first sub-bridge circuit 31 is also referred to as the first sub-coil 61, the coil 62 provided for the second sub-bridge circuit 32 is also referred to as the second sub-coil 62, the coil 63 provided for the third sub-bridge circuit 33 is also referred to as the third sub-coil 63, and the coil 64 provided for the fourth sub-bridge circuit 34 is also referred to as the fourth sub-coil 64.

The main coil 60 is arranged in the main connection path 70. The main connection path 70 is a path that connects a junction between the first switch S1 and the second switch S2 of the main bridge circuit 30 and a junction between the third switch S3 and the fourth switch S4 of the main bridge circuit 30. In other words, the main coil 60 is connected to the main bridge circuit 30 using the main connection path 70.

Each of the first to fourth sub-coils 61 to 64 is arranged in a corresponding one of the first to fourth sub-connection paths 71 to 74. By way of example, the first sub-coil 61 is disposed in the first sub-connection path 71. The first sub-connection path 71 is a path that connects a junction between the first switch ST1 and the second switch ST2 of the first sub-bridge circuit 31 and a junction between the third switch ST3 and the fourth switch ST4 of the first sub-bridge circuit 31. In other words, the first sub-coil 61 is connected to the first sub-bridge circuit 31 through the first sub-connection path 71. Connection relationships between the second sub-connection path 72 and the second sub-bridge circuit 32, between the third sub-connection path 73 and the third sub-bridge circuit 33, and between the fourth sub-connection path 74 and the fourth sub-bridge circuit 34 are the same as the connection relationship between the first sub-connection path 71 and the first sub-bridge circuit 31.

The coils 60 to 64 are magnetically coupled to each other via a core included in the transformer 50. When a potential developed at the first end of the main coil 60 becomes higher than that at the second end thereof, it will cause voltage to be induced at each of the sub-coils 61 to 64 such that the potential at the first end thereof becomes higher than that at the second end thereof. Conversely, when the potential at the second end of the main coil 60 becomes higher than that at the first end thereof, it will cause voltage to be induced at each of the sub-coils 61 to 64 such that the potential at the second end thereof becomes higher than that at the first end thereof.

In the following discussion, when the potential at the first end of each of the coils 60 to 64 is higher than that at the second end thereof, a polarity of voltage at each of the coils 60 to 64 is defined as a positive polarity. Conversely, when the potential at the second end is higher than that at the first end, the polarity of the voltage at each of the coils 60 to 64 is defined as a negative polarity.

The power supply system also includes the first to fifth voltage sensors 51 to 55. The first voltage sensor 51 works to measure a first voltage V1, which is a terminal voltage at the sub-capacitor 36 of the first sub-bridge circuit 31. The second voltage sensor 52 works to measure a second voltage V2, which is a terminal voltage at the sub-capacitor 37 of the second sub-bridge circuit 32. The third voltage sensor 53 works to measure a third voltage V3, which is a terminal voltage at the sub-capacitor 38 of the third sub-bridge circuit 33. The fourth voltage sensor 54 works to measure a fourth voltage V4, which is a terminal voltage at the sub-capacitor 39 of the fourth sub-bridge circuit 34. The fifth voltage sensor 55 works to measure a fifth voltage V5, which is a terminal voltage at the main capacitor 35 of the main bridge circuit 30. The first to fifth voltages V1 to V5 measured by the sensors 51 to 55 are inputted to the controller 40.

The controller 40 works to perform a power transmission control task for bidirectionally transmitting electric power between the power system 10 connected to the power converter 20 and each of the first to fourth batteries 11 to 14. In the power transmission control task, the controller 40 alternately turns on one of the first switches S1, ST1, SU1, SV1, and SW1 and a corresponding one of the second switches S2, ST2, SU2, SV2, and SW2 and also alternately turns on one of the third switches S3, ST3, SU3, SV3, and SW3 and a corresponding one of the fourth switches S4, ST4, SU4, SV4, and SW4 which are installed in a corresponding one of the bridge circuits 30 to 34.

Each of the bridge circuits 30 to 34 works to periodically change the polarity of the alternating voltage applied to a corresponding one of the coils 60 to 64. Taking the main bridge circuit 30 as an example, when the first switch S1 and the fourth switch S4 are turned on, while the second switch S2 and the third switch S3 are turned off, it causes the polarity of the voltage of the main coil 60 to be changed to be positive. Alternatively, when the first switch S1 and the fourth switch S4 are turned off, while the second switch S2 and the third switch S3 are turned on, it causes the polarity of the voltage of the main coil 60 to be changed to be negative.

The controller 40 works to control electrical power transmitted between the power system 10 and each of the batteries 11 to 14 as a function of a switching time of the polarity of the voltage applied to a corresponding one of the coils 60 to 64. Specifically, the controller 40 delays the switching time to the positive polarity of voltage applied by a first bridge circuit to a corresponding one of the coils 60 to 64 as compared with those applied by second bridge circuits to corresponding ones of the coils 60 to 64. The first bridge circuit is one of the bridge circuits 30 to 34 which is required to receive power from the other bridge circuits (i.e., the second bridge circuits). The controller 40 controls the switching timing of the polarity of the voltage applied to each of the coils 60 to 64 by switching control of the switches S1 to S4, ST1 to ST4, SU1 to SU4, SV1 to SV4, or SW1 to SW4. In this embodiment, switching cycles (i.e., on-off cycles) of the switches S1 to S4, ST1 to ST4, SU1 to SU4, SV1 to SV4, and SW1 to SW4 installed in the bridge circuits 30 to 34 are identical with each other.

FIG. 3 demonstrates an example of a power transmission control task performed by the controller 40. The controller includes the phase control unit 41 and the signal generator 42.

The phase control unit 41 receives required powers Pb1 to Pb4 required by the first to fourth batteries 11 to 14 to receive, and the first to fifth voltages V1 to V5. Each of the required powers Pb1 to Pb4 is electrical power required to charge a corresponding one of the first to fourth batteries 11 to 14 or electrical power required to discharge a corresponding one of the first to fourth batteries 11 to 14 to the power converter 20. The controller 40 may analyze information transmitted from the vehicle connected to the external terminal of one of the sub-bridge circuits 31 to 34 to calculate a corresponding one of the required powers Pb1 to Pb4. The controller 40 may use, as the first to fifth voltages V1 to V5, values measured by the first to fifth voltage sensors 51 to 55.

The phase control unit 41 determines the switching timing to the positive polarity of voltage applied to a selected one of the coils 60 to 64 as a function of a corresponding one of the required power Pb1 to Pb4 and a corresponding one of the first to fifth voltages V1 to V5. Specifically, the phase control unit 41 calculates a command received power (i.e., a target received power) and a command transmission power (i.e., a target transmission power) using a corresponding one of the required power Pb1 to Pb4. The command received power is a target electrical power required to be received by a power receiving circuit. The power receiving circuit is at least one of the sub-bridge circuits 31 to 34 that is required to receive power from the remaining circuits of the sub-bridge circuits 31 to 34. When there are a plurality of the power receiving circuits, the command received power is a total power of the command powers required to be received by the plurality of the power receiving circuits. The command transmission power is a target electrical power required to be transmitted from a power transmission circuit. The power transmission circuit is at least one of the sub-bridge circuits 31 to 34 that is required to transmit the power to a remaining one(s) of the sub-bridge circuits 31 to 34. When there are a plurality of the power transmission circuits, the command transmission power is a total power of target electrical powers required for the plurality of the transmission circuits to output. The phase control unit 41 sets a first phase difference θa and a second phase difference θb based on the command received power, the command transmission power, and a corresponding one or some of the first to fifth voltages V1 to V5.

The first phase difference θa is a difference between a switching timing to the positive polarity of voltage applied to one of the coils 61 to 64 which corresponds to the power transmission circuit and a switching timing to the positive polarity of voltage applied to one of the coils 61 to 64 which is used with the power receiving circuit. For example, the controller 40 sets the first phase difference θa to be higher with an increase in a smaller one of the command received power and the command transmission power.

The second phase difference θb is a difference between a timing of switching to the positive polarity of voltage applied to the main coil 60 and a timing of switching to the positive polarity of the voltage applied to one of the coils 61 to 64 which is used with the power transmission circuit, when the main bridge circuit 30 is required to receive power from the power transmission circuit. Alternatively, the second phase difference θb may also be set to a difference between a timing of switching to the positive polarity of voltage applied to the main coil 60 and a timing of switching to the positive polarity of voltage applied to one of the coils 61 to 64 which is used with the power receiving circuit, when the main bridge circuit is required to transmit power to the power receiving circuit. For example, the controller 40 sets the second phase difference θb to a larger value as a power difference between the command transmission power and the command received power becomes larger.

The signal generator 42 works to generate drive signals for the switches S1 to S4, ST1 to ST4, SU1 to SU4, SV1 to SV4, and SW1 to SW4, as a function of the first phase difference θa or the second phase difference θb determined in the above way and outputs the generated drive signals to gates of the switches S1 to S4, ST1 to ST4, SU1 to SU4, SV1 to SV4, and SW1 to SW4. Each of the drive signals is produced in the form of an on-signal or an off-signal. Each of the switches S1 to S4, ST1 to ST4, SU1 to SU4, SV1 to SV4, and SW1 to SW4 is turned on or off in response to input of the drive signal to the gate thereof.

The magnetic coupling of the coils 60 to 64 with each other through the core of the transformer 50 usually leads to a risk that the power transmission control operations of the bridge circuits 30 to 34 may interfere with each other, which causes a large amount of current to flow in any of the bridge circuits 30 to 34. In this case, there is a concern that an overcurrent exceeding a rated current set in each of the bridge circuits 30 to 34 may flow into a corresponding one of the bridge circuits 30 to 34.

A unique structure of the power converter 20 in this embodiment designed to minimize the risk of flow of overcurrent in the bridge circuits 31 to 34 will be described below.

It is conceivable to design the power converter 20 such that a rated power of any one of the bridge circuits 30 to 34 is made larger than rated powers of the remaining ones of the bridge circuits 30 to 34. In this embodiment, the rated power of the main bridge circuit 30 is set higher than that of each of the sub-bridge circuits 31 to 34. This structure permits a larger current than that in each of the sub-bridge circuits 31 to 34 to flow in the main bridge circuit 30.

The rated power of each of the sub-bridge circuits 31 to 34 is defined as a maximum value of power that enables a corresponding one of the sub-bridge circuits 31 to 34 to be operated continuously when the temperature of a corresponding one of the sub-bridge circuits 31 to 34 reaches a rated ambient temperature, and is determined, for example, as a function of a rated voltage at a corresponding one of the batteries 11 to 14. The rated power of the main bridge circuit 30 is determined, for example, based on the sum of the rated powers of the respective sub-bridge circuits 31 to 34. In this case, even when each of the sub-bridge circuits 31 to 34 transmits or receives power at the rated power, it becomes possible to make a current flowing through the main bridge circuit 30 equal to or less than a rated current thereof.

In this embodiment, an impedance of the main connection path 70 that connects the main bridge circuit 30 and the main coil 60 together is set lower than those of the sub-connection paths 71 to 74 that connect the respective sub-bridge circuits 31 to 34 and the respective sub-coils 61 to 64.

Specifically, the inductors 81 to 84, which are external passive devices, are arranged in the sub-connection paths 71 to 74. In other words, the inductors 81 to 84 are connected in series to the sub-coils 61 to 64. In this case, an inductance of each of the sub-connection paths 71 to 74 is equal to the sum of the inductance of a corresponding one of the inductors 81 to 84 and a leakage inductance of a corresponding one of the sub-coils 61 to 64.

No external inductor is disposed in the main connection path 70. This causes an inductance of the main connection path 70 to be substantially equal to a leakage inductance of the main coil 60, so that the inductance of the main connection path 70 is lower than those of the sub-connection paths 71 to 74. The above arrangements, therefore, realize 10) a state where the impedance of the main connection path 70 is lower than that of each of the sub-connection paths 71 to 74. It is to be noted that FIG. 1 demonstrates the leakage inductance 80 of the main coil 60 as being the inductance of the main connection path 70. The inductance of each of the connection paths 70 to 74 may include a wiring inductance thereof.

The above-described embodiment offers the following beneficial advantages.

As apparent from the above discussion, the structure in the first embodiment is designed to have the impedance of the main connection path 70 which is set lower than that of each of the sub-connection paths 71 to 74 that connect the sub-bridge circuits 31 to 34 and the sub-coils 61 to 64, respectively. The main connection path 70 is, as described above, an electrical path which connects the main coil 60 with the main bridge circuit 30 which has the highest rated power among the bridge circuits 30 to 34. These arrangements facilitate flow of ac current in the main bridge circuit 30 as compared with the sub-bridge circuits 31 to 34, that is, promote the flow of current in the main bridge circuit 30 which is larger than that in each of the sub-bridge circuits 31 to 34, however, it is achieved safely since the rated power of the main bridge circuit 30 is set larger than those of the sub-bridge circuits 31 to 34. Therefore, an electrical current flowing through the main bridge circuit 30 becomes equal to or less than a rated current of the main bridge circuit 30. On the other hand, as compared with a case in which the impedance of the main connection path 70 is larger than or equal to those of the sub-connection paths 71 to 74, the current flowing through the sub-bridge circuits 31 to 34 is reduced, and an overcurrent flowing through the sub-bridge circuits 31 to 34 is suppressed. This minimizes or eliminates the risk that an excessive current may flow through the bridge circuits 30 to 34.

### Second Embodiment

The second embodiment assumes an operation state of the power converter 20 in which an excessive current flows through any one of the sub-bridge circuits 31 to 34 and determines the impedance of each of the connection paths 70 to 74 in order to minimize a risk that the excessive current may flow in the assumed operation state.

Specifically, in the following operation state of the power converter 20, it is anticipated that an excessive current may flow through any one of the sub-bridge circuits 31 to 34.

When each of the sub-bridge circuits 31 to 34 is required to operate as the power receiving circuit or the power transmission circuit, the power outputted from the power transmission circuit may be greater than the power inputted to the power receiving circuit. The controller 40 works to control the switching operations of the main bridge circuit 30, the power receiving circuit, and the power transmission circuit such that the timing of switching to the positive polarity of voltage applied to the main coil 60 and the timing of switching to the positive polarity of voltage applied to one of the coils 61 to 64 used with the power receiving circuit are delayed relative to the timing of switching to the positive polarity of voltage applied to one of the coils 61 to 64 used with the power transmission circuit. This causes the power to be transmitted from the power transmission circuit to the main bridge circuit 30 in a period of time in which the polarities of voltages applied to the main coil 60 and one of the coils 61 to 64 used with the power transmission circuit are different from each other and also causes the power to be transmitted from the power transmission circuit to the power receiving circuit in a period of time in which the polarities of voltages applied to one of the coils 61 to 64 used with the power receiving circuit and one of the coils 61 to 64 used with the power transmission circuit are different from each other.

When the timing of switching to the positive polarity of voltage applied to the main coil 60 is delayed relative to the timing of switching to the positive polarity of voltage applied to one of the coils 61 to 64 which is used with the power receiving circuit, the power receiving circuit may serve as a power relay to transfer electrical power between the power transmission circuit and the main bridge circuit 30. In such a power transferring operation (which will also be referred to below as a power relay operation), the power receiving circuit receives power from the power transmission circuit and supplies the power to the main bridge circuit 30. In this case, due to the transfer of excessive power in the power receiving circuit during the power transferring operation, there is a concern that an overcurrent may flow through the power receiving circuit.

For example, the required power Pb1 of the first battery 11 is defined as power P0 used for electrically charging the first battery 11 from the power converter 20, and the required powers Pb2 to Pb4 of the second to fourth batteries 12 to 14 are defined as power P0 used for electrically discharging from the second to fourth batteries 12 to 14 to the power converter 20. In this case, as shown in FIG. 4, the power converter 20 operates such that the first sub-bridge circuit 31 receives power P0, and the second to fourth sub-bridge circuits 32 to 34 transmit power P0. Here, the power P0 is a rated power of each of the sub-bridge circuits 31 to 34.

In the operation state shown in FIG. 4, the phase control unit 41 sets the first phase difference θa and the second phase difference θb, with the command received power defined as P0 and the command transmission power defined as 3×P0. Specifically, since the command received power is P0 and the command transmission power is 3×P0, the phase control unit 41 sets the first phase difference θa such that power P0 is transmitted from the power transmission circuit to the power receiving circuit. Further, since the power difference between the command transmission power and the command received power is 2×P0, the phase control unit 41 sets the second phase difference θb such that power 2×P0 is transmitted from the power transmission circuit to the main bridge circuit 30. The signal generator 42 generates drive signals based on the set first phase difference θa and second phase difference θb.

The on-off switching operations of the switches S1 to S4, ST1 to ST4, SU1 to SU4, SV1 to SV4, and SW1 to SW4 of the bridge circuits 30 to 34 in response to the above-described drive signals may cause the voltages Vc1, Vc2, and Vc3 at the coils 60 to 64 to have waveforms shown in FIGS. 5(a) to 5(c). FIGS. 5(a) to 5(c) illustrate a comparative example of voltage waveforms in a case where the inductances of the connection paths 70 to 74 are assumed to be the same. FIG. 5(a) shows a transition of the voltage Vc1 at one of the coils 61 to 64 which is used for the power transmission circuit. FIG. 5(b) shows a transition of the voltage Vc2 at one of the coils 61 to 64 which is used for the power receiving circuit. FIG. 5(c) shows a transition of the voltage Vc3 developed at the main coil 60 of the main bridge circuit 30. Specifically, in the illustrated example, the voltage at one of the coils 61 to 64 which is used with the power transmission circuit is voltage at each of the coils 62 to 64, while one of the coils 61 to 64 which is used with the power receiving circuit is voltage at the coil 61.

In the comparative example demonstrated in FIGS. 5(a) to 5(c), the switching timings of the polarities of voltages Vc1, Vc2, and Vc3 at the respective coils are shifted relative to one another. Specifically, within one switching period Tsw, compared with a first timing at which the voltage Vc1 at one of the coils 61 to 64 which is used with the power transmission circuit is switched to the positive polarity, a second timing at which the voltage Vc2 at one of the coils 61 to 64 which is used with the power receiving circuit is switched to the positive polarity is delayed by a phase difference θ12. Further, within one switching period Tsw, compared with the first timing, a third timing at which the voltage Vc3 at the main coil 60 is switched to the positive polarity is delayed by a phase difference θ31.

For example, during a period corresponding to the phase difference θ12, power is transmitted from the power transmission circuit to the power receiving circuit. Further, during a period corresponding to the phase difference θ31, power is transmitted from the power transmission circuit to the main bridge circuit 30. Each of the phase differences θ12 and θ31 corresponds to a power receiving time during which power is received from the power transmission circuit. In the example of FIGS. 5(a) to 5(c), the power receiving time of the power receiving circuit is shorter than the power receiving time of the main bridge circuit 30.

When the phase difference θ12 is, as shown in FIGS. 5(b) and 5(c), shorter than the phase difference θ31, a shift also occurs between the second timing and the third timing. During a period corresponding to the phase difference θ23 between the second timing and the third timing, power is transmitted from the power receiving circuit to the main bridge circuit 30. In this case, the power receiving circuit not only receives power from the power transmission circuit during the period corresponding to the phase difference θ12, but also performs the power transferring operation of transmitting power to the main bridge circuit 30 during the period corresponding to the phase difference θ23. During the power transferring operation, since the power receiving circuit receives additional power from the power transmission circuit by an amount corresponding to the power to be transmitted to the main bridge circuit 30, there is concern that an overcurrent may flow in the power receiving circuit.

The operating state of the power converter 20 shown in FIG. 4 is a situation in which, among the sub-bridge circuits 31 to 34, only the first sub bridge circuit 31 serves as the power receiving circuit, while the remaining second to fourth sub bridge circuits 32 to 34 serve as the power transmission circuit, and both the power receiving circuit and the power transmission circuit operate at a rated power. In this case, it is a concern that the power transferring operation is likely to occur in the first sub-bridge circuit 31 serving as the power receiving circuit. Furthermore, since each of the sub-bridge circuits 31 to 34 is operating at the rated power, there is a concern that, when the power transferring operation is carried out in the first sub bridge circuit 31, an overcurrent is likely to flow through the first sub bridge circuit 31.

In view of the above, the power converter 20 in this embodiment has the following unique configuration.

In the operating state of the power converter 20 shown in FIG. 4, when the phase difference θ31 between the third timing and the first timing is, as illustrated in FIGS. 6(a) to 6(c), equal to the phase difference θ12 between the first timing and the second timing, it is considered that the power transferring operation is suppressed from occurring in each of the sub-bridge circuits 31 to 34. Furthermore, even in the operating state of the power converter 20 shown in FIG. 4, when the phase difference θ31 is smaller than the phase difference θ12, it is also considered that the power transferring operation is suppressed from occurring in each of the sub-bridge circuits 31 to 34. It should be noted that FIGS. 6(a) to 6(c) correspond to FIGS. 5(a) to 5(c), respectively.

Accordingly, the controller 40 executes switching control of each of the bridge circuits 30 to 34 to satisfy the following first power receiving condition and second power receiving condition. The first power receiving condition is a condition in which the timing of switching to the positive polarity of voltage applied to the main coil 60 and the timing of switching to the positive polarity of voltage applied to one of the coils 61 to 64 which is used with the power receiving circuit are delayed relative to the timing of switching to the positive polarity of voltage applied to one of the coils 61 to 64 which is used with the power transmission circuit. The second power receiving condition is a condition in which the timing of switching to the positive polarity of voltage applied to the main coil 60 is set earlier than the timing of switching to the positive polarity of voltage applied to one of the coils 61 to 64 which is used with the power receiving circuit. In other words, the second power receiving condition is a condition in which the magnitude relationship between the phase differences θ12 and θ31 is set to meet a relation of θ12≥θ31.

In order for the switching control of each of the bridge circuits 30 to 34 to be performed so as to satisfy the first power receiving condition and the second power receiving condition, it is necessary that the power receiving time from the power transmission circuit to the main bridge circuit 30 be equal to or shorter than the power receiving time from the power transmission circuit to the power receiving circuit. In this respect, in this embodiment, in the operating state of the power converter 20 shown in FIG. 4, the impedances of the respective connection paths 70 to 74 are determined as a function of the rated powers P0 of the sub-bridge circuits 31 to 34, so as to execute the switching control that satisfies the first power receiving condition and the second power receiving condition.

In a situation where each of the sub-bridge circuits 31 to 34 operates with the rated power P0, the magnitude relationship between the phase difference θ12 between the first timing and the second timing and the phase difference θ31 between the third timing and the first timing corresponds to the magnitude relationship between a power ratio, which is a ratio of the power received by the power receiving circuit to that received by the main bridge circuit 30, and an inductance ratio L1/LT2, which is a ratio of the inductance L1 of the main connection path 70 to the inductance LT2 of each of the sub-connection paths 71 to 74. Specifically, in order to achieve relation of θ12>θ31, the inductance ratio L1/LT2 may be set smaller than the power ratio, while in order to achieve a relation of θ12=θ31, the inductance ratio L1/LT2 may be set equal to the power ratio.

As described in the first embodiment, the inductance L1 of the main connection path 70 corresponds to the leakage inductance of the main coil 60. The inductance LT2 of each of the sub-connection paths 71 to 74 is a value obtained by converting, based on the turn ratio between the main coil 60 and a corresponding one of the sub-coils 61 to 64, a total inductance L2 that is the sum of the inductance of a corresponding one of the inductors 81 to 84 and the leakage inductance thereof. Specifically, when the number of turns of the main coil 60 is given by n1 and the number of turns of each of the sub-coils 61 to 64 is given by n2, the inductance LT2 of each of the sub-connection paths 71 to 74 is given by the following expression e1.

$$L {T}_{2} = {( \frac{{n}_{1}}{{n}_{2}} )}^{2} {L}_{2} \qquad e 1$$

Assuming the situation shown in FIG. 4, the main bridge circuit 30 receives a differential power of 2×P0, which is obtained by subtracting the rated power P0 of the first sub-bridge circuit 31 from a total power of 3×P0 that is the sum of the rated powers of the second to fourth sub-bridge circuits 32 to 34. Accordingly, the power ratio is a ratio of the rated power P0 of the first sub-bridge circuit 31, which serves as the power receiving circuit, to the received power 2×P0 of the main bridge circuit 30, i.e., ½. In this embodiment, the impedances of the respective connection paths 70 to 74 are determined such that the inductance ratio L1/LT2 is smaller than the power ratio.

FIG. 7 is a diagram showing, in the operating state of the power converter 20 illustrated in FIG. 4, the relationship between the inductance ratio L1/LT2 and the peak value Ip1 of the current flowing through the main bridge circuit 30 and the peak value Ip2 of the current flowing through each of the sub-bridge circuits 31 to 34. In FIG. 7, a solid line represents the peak value Ip1 of the current flowing through the main bridge circuit 30, and a broken line represents the peak value Ip2 of the current flowing through each of the sub-bridge circuits 31 to 34.

When the inductance ratio L1/LT2 is smaller than 0.5, it enables the main bridge circuit 30 to perform the power transferring operation without allowing each of the sub-bridge circuits 31 to 34 to perform the power transferring operation. This causes, in a region shown in FIG. 7 where the inductance ratio L1/LT2 is smaller than 0.5, the peak value Ip2 of the current flowing through each of the sub bridge circuits 31 to 34 is reduced as compared with the peak value Ip1 of the current flowing through the main bridge circuit 30. Although the peak value Ip1 of the current flowing through the main bridge circuit 30 increases as the inductance ratio L1/LT2 decreases, the rated power of the main bridge circuit 30 is determined as a function of a total of power each of the sub-bridge circuits 31 to 34 transmits or receives at the rated power, thereby causing the current flowing through the main bridge circuit 30 to be equal to or less than the rated current.

The above-described embodiment offers the following beneficial advantages.

The switching control of each of the bridge circuits 30 to 34 is, as described above, performed to have the timing of switching to the positive polarity of voltage applied to the main coil 60 which is earlier than that to the polarity of voltage applied to one of the coils 61 to 64 which is used with the power receiving circuit. This requires the need to make the power receiving time from the power transmission circuit to the main bridge circuit 30 equal to or shorter than the power receiving time from the power transmission circuit to the power receiving circuit. In this regard, the main bridge circuit 30 is configured to allow an alternating current to flow more easily than in each of the sub-bridge circuits 31 to 34. The main bridge circuit 30, therefore, has a structure suitable for shortening the power receiving time from the power transmission circuit to the main bridge circuit 30. This enables the power supply system in this embodiment to accurately execute switching control of the power converter without allowing the power transferring operation to be performed in the power receiving circuit, and also minimizes a risk of an overcurrent flowing in the power receiving circuit.

In a situation of operation of the power converter 20 in which the power transferring operation of the power receiving circuit may result in flow of an overcurrent in the power receiving circuit, the power ratio is defined as a ratio of the rated power of the power receiving circuit to the received power of the main bridge circuit 30. The power ratio is used to determine the impedance of the main connection path 70 and the impedances of the sub-connection paths 71 to 74. This enables the impedances of the bridge circuits 30 to 34 to be determined to inhibit the power transferring operation from being performed by the power receiving circuit in an assumed operation situation of the power converter 20 in which an overcurrent tends to flow in the power receiving circuit. This achieves accurate switching control of the power converter 20 without allowing the power transferring operation to be performed in the power receiving circuit.

### Modification of the Second Embodiment

The impedances of the connection paths 70 to 74 may be determined to have the inductance ratio L1/LT2 which is equal to the power ratio. In a case of assuming the operating situation shown in FIG. 4, the impedances of the connection paths 70 to 74 may be determined such that the inductance ratio becomes ½.

When the inductance ratio L1/LT2 is set to be equal to 0.5, it suppresses an increase in current flowing through the main bridge circuit 30 and also inhibits the power transferring operation from being performed by each of the sub-bridge circuits 31 to 34. This, as can be seen in FIG. 7, reduces both the peak value Ip1 of the current flowing through the main bridge circuit 30 and the peak value Ip2 of the current flowing through each of the sub bridge circuits 31 to 34. It is, therefore, possible to prevent the current flowing through the main bridge circuit 30 from increasing and thereby prevent an increase in power loss, while not allowing the power transferring operation to be performed in each of the sub-bridge circuits 31 to 34.

The impedances of the connection paths 70 to 74 may alternatively be determined to have the inductance ratio L1/LT2 which is approximately equal to the power ratio. For example, when the inductance ratio L1/LT2 is larger than or equal to the power ratio within a range where the peak value Ip2 of the current flowing through each of the sub-bridge circuits 31 to 32 is lower than the peak value Ip1 of the current flowing through the main bridge circuit 30, the inductance ratio L1/LT2 may be regarded as being approximately equal to the power ratio. Taking FIG. 7 as an example, when 0.5≤L1/LT2<0.6, the inductance ratio L1/LT2 may be regarded as being approximately equal to the power ratio.

Even in situations of operation of the power converter other than that demonstrated in FIG. 4, there is a concern that an excessive current may flow through one of the sub-bridge circuits 31 to 34. Specifically, in a case where each of the sub-bridge circuits 31 to 34 operates as the power receiving circuit or the power transmission circuit, the amount of power received by the power receiving circuit may become greater than the amount of power outputted from the power transmission circuit. In this case, the power converter 20 works to perform switching control of the main bridge circuit 30, the power transmission circuit, and the power receiving circuit such that the timing of switching to the positive polarity of voltage applied to the main coil 60 and the timing of switching to the positive polarity of voltage applied to one of the coils 61 to 64 which is used with the power transmission circuit both advance relative to the timing of switching to the positive polarity of voltage applied to one of the coils 61 to 64 which is used with the power receiving circuit. This causes, in a period in which the polarities of voltages applied to the main coil 60 and one of the coils 61 to 64 which is used with the power receiving circuit are different from each other, power to be transferred from the main bridge circuit 30 to the power receiving circuit, and in a period in which the polarities of voltages applied to one of the coils 61 to 64 which is used with the power receiving circuit and one of the coils 61 to 64 which is used with the power transmission circuit are different from each other, power to be transferred from the power transmission circuit to the power receiving circuit.

When the timing of switching to the positive polarity of voltage applied to the main coil 60 is advanced relative to the timing of switching to the positive polarity of voltage applied to one of the coils 61 to 64 which is used with the power transmission circuit, the power transmission circuit may perform the power transferring operation of relaying power transfer between the main bridge circuit 30 and the power receiving circuit. In the power transferring operation, the power transmission circuit receives power from the main bridge circuit 30 and then transmits the power to the power receiving circuit. In this case, there is a concern that an overcurrent flows through the power transmission circuit due to transmission of excess power in the power transmission circuit during the power transferring operation.

For example, the required power Pb1 of the first battery 11 may be set to the rated power P0 for discharging from the first battery 11 to the power converter 20, and the required powers Pb2 to Pb4 of the second to fourth batteries 12 to 14 may be set to the rated power P0 for charging from the power converter 20 to the second to fourth batteries 12 to 14. In this case, the power converter 20 works to operate the first sub bridge circuit 31 to transmit the rated power P0, and also operate the second to fourth sub bridge circuits 32 to 34 to receive the rated power P0.

In the above-described operating situation, the phase control unit 41 sets the command received power to 3×P0 and the command transmission power to P0, and determines the first phase difference θa and the second phase difference θb. Specifically, since the command received power is 3×P0 and the command transmission power is P0, the phase control unit 41 determines the first phase difference θa such that power P0 is transferred from the power transmission circuit to the power receiving circuit. Further, since the difference power between the command received power and the command transmission power is set to 2×P0, the phase control unit 41 determines the second phase difference θb such that power 2×P0 is transferred from the main bridge circuit 30 to the power receiving circuit. The signal generator 42 generates drive signals as a function of the determined first phase difference θa and second phase difference θb.

The on-off operations of the switches S1 to S4, ST1 to ST4, SU1 to SU4, SV1 to SV4, and SW1 to SW4 of the bridge circuits 30 to 34 in response to the above-described drive signals may cause the waveforms of voltages Vc1, Vc2, and Vc3 at the respective coils to become, for example, those shown in FIGS. 8(a) to 8(c). FIGS. 8(a) to 8(c) illustrate a comparative example of voltage waveforms in a case where the inductances of the connection paths 70 to 74 are made the same. FIG. 8(a) corresponds to FIG. 5(c), FIG. 8(b) corresponds to FIG. 5(a), and FIG. 8(c) corresponds to FIG. 5(b).

In the example of FIGS. 8(a) to 8(c), the polarity switching timings of voltages Vc1, Vc2, and Vc3 at the main coil 60, and ones of the coils 61 to 64 which are used with the power receiving circuit and the power transmission circuit are shifted from one another. Specifically, within one switching period Tsw, compared to the second timing at which the voltage Vc2 at one of the coils 61 to 64 used with the power receiving circuit is switched to the positive polarity, the second timing at which the voltage Vc1 at one of the coils 61 to 64 used with the power transmission circuit is switched to the positive polarity is advanced by a phase difference θ12. Furthermore, compared to the second timing, the third timing at which the voltage Vc3 at the main coil 60 is switched to the positive polarity is advanced by a phase difference θ23.

For example, during a period corresponding to the phase difference θ12, electric power is transmitted from the power transmission circuit to the power receiving circuit. During a period corresponding to the phase difference θ23, electric power is transmitted from the main bridge circuit 30 to the power receiving circuit. Each of the phase differences θ12 and θ23 corresponds to a transmission time during which power is supplied to the power receiving circuit. In the example of FIGS. 8(a) to 8(c), the transmission time of the power transmission circuit is shorter than the transmission time of the main bridge circuit 30.

As shown in FIGS. 8(a) to 8(c), when the phase difference θ12 is shorter than the phase difference θ23, it also results in a shift between the third timing and the first timing. During a period corresponding to the phase difference θ31, electric power is transmitted from the main bridge circuit 30 to the power transmission circuit. In this case, the power transmission circuit performs the power transferring operation in which the power transmission circuit receives electric power from the main bridge circuit 30 during the period corresponding to the phase difference θ31, and then transmits the electric power to the power receiving circuit during the period corresponding to the phase difference θ12. In the power transferring operation, it is a concern that an overcurrent may flow through the power transmission circuit due to the fact that the power transmission circuit transmits additional electric power to the power receiving circuit corresponding to the amount received from the main bridge circuit 30.

The operating condition of the power converter 20 described above is a condition in which, among the sub-bridge circuits 31 to 34, only the first sub-bridge circuit 31 works as the power transmission circuit, the remaining second to fourth sub-bridge circuits 32 to 34 each work as the power receiving circuits, and both the power receiving circuits and the power transmission circuit operate at a rated power. In this case, there is a possibility that the power transferring operation is likely to be performed in the first sub-bridge circuit 31 serving as the power transmission circuit.

Furthermore, since each of the sub-bridge circuits 31 to 34 is operating at the rated power, an overcurrent may occur in the first sub-bridge circuit 31 when the power transferring operation is performed therein.

As demonstrated in FIGS. 9(a) to 9(c), when θ12=θ23 or when θ12>θ23, it is considered that the power transferring operation in each of the sub-bridge circuits 31 to 34 can be suppressed. The controller 40, therefore, executes switching control of each of the bridge circuits 30 to 34 so as to satisfy the following first power transmission condition and second power transmission condition. The first power transmission condition is a condition in which the timing of switching to the positive polarity of voltage applied to the main coil 60 and the timing of switching to the positive polarity of voltage applied to one of the coils 61 to 64 used with the power transmission circuit are advanced relative to the timing of switching to the positive polarity of voltage applied to one of the coils 61 to 64 used with the power receiving circuit. The second power transmission condition is a condition in which the timing of switching to the positive polarity of voltage applied to the main coil 60 is set to a timing after the timing of switching to the positive polarity of voltage applied to one of the coils 61 to 64 used with the power transmission circuit. In other words, the second power transmission condition is a condition in which the magnitude relation between the phase differences θ12 and θ23 is set to meet a relation of θ12≥θ23. It is to be noted that FIGS. 9(a) to 9(c) correspond to FIGS. 8(a) to 8(c) described above.

In order for the switching control of each of the bridge circuits 30 to 34 to be performed to satisfy the first power transmission condition and the second power transmission condition, it is necessary that the power transmission time from the main bridge circuit 30 to the power receiving circuit be equal to or shorter than the power transmission time from the power transmission circuit to the power receiving circuit. In this regard, in the above-described operating condition, the impedance of each of the connection paths 70 to 74 is set as a function of the rated power P0 of a corresponding one of the sub-bridge circuits 31 to 34 in order to execute switching control that satisfies the first power receiving condition and the second power receiving condition.

In a situation where each of the sub-bridge circuits 31 to 34 operates at the rated power P0, the magnitude relation between the phase differences θ12 and θ23 corresponds to the magnitude relation between a power ratio, which is a ratio of the transmission power of the power transmission circuit to the transmission power of the main bridge circuit 30, and the above-described inductance ratio L1/LT2. Specifically, in order to satisfy the relation of θ12≥θ23, it is sufficient that the inductance ratio L1/LT2 be equal to or less than the power ratio. Therefore, by determining the impedance of each of the connection paths 70 to 74 such that the inductance ratio L1/LT2 is equal to or less than the power ratio, it is possible to suppress the power transferring operation from being performed in each of the sub-bridge circuits 31 to 34.

For example, assuming a situation in which, among the sub-bridge circuits 31 to 34, only the first sub-bridge circuit 31 works as the power transmission circuit, the remaining second to fourth sub-bridge circuits 32 to 34 work as the power receiving circuits, and both the power receiving circuit and the power transmission circuit operate at the rated power, the power ratio will be ½. Therefore, by setting the impedance of each of the connection paths 70 to 74 such that the inductance ratio L1/LT2 is equal to or less than ½, it is possible to suppress the power transferring operation from being performed in a corresponding one of the sub-bridge circuits 31 to 34 in the assumed operating condition.

The above-described embodiment offers the following beneficial advantages.

The switching control of each of the bridge circuits 30 to 34 is, as described above, performed to have the timing at which the voltage applied to the main coil 60 is switched to the positive polarity and which becomes a timing after the timing at which voltage applied to one of the coils 61 to 64 which is used with the power transmission circuit is switched to the positive polarity. In this case, it is necessary to make the power transmission time from the main bridge circuit 30 to the power receiving circuit equal to or shorter than the power transmission time from the power transmission circuit to the power receiving circuit. In this respect, since the main bridge circuit 30 is configured such that an alternating current is more likely to flow as compared with each of the sub-bridge circuits 31 to 34, it constitutes a configuration suitable for shortening the power transmission time from the main bridge circuit 30 to the power receiving circuit. It is, therefore, possible to appropriately perform switching control for suppressing the power transferring operation in the power transmission circuit, and to appropriately suppress an overcurrent flowing in the power transmission circuit.

In the power transmission circuit, assuming an operating condition of the power converter 20 in which an overcurrent is likely to flow in the power transmission circuit when the power transferring operation is performed, the power ratio is, as described above, defined as a ratio of the rated power of the power transmission circuit to the transmission power of the main bridge circuit 30 under the assumed condition. Based on the power ratio, the impedance of the main connection path 70 and the impedances of the sub-connection paths 71 to 74 are set. In this case, assuming an operating condition of the power converter 20 in which an overcurrent is likely to flow in the power transmission circuit, the impedances of each of the bridge circuits 30 to 34 are determined so as to suppress the power transferring operation by the power transmission circuit under the assumed operating condition. This ensures the stability in achieving switching control operation to avoid the power transferring operation in the power transmission circuit

When the number of the sub-bridge circuits 31 to 34 is more than four, the impedance of each of the connection paths 70 to 74 may be determined to have the inductance ratio L1/LT2 which is equal to or less than the power ratio. Specifically, in a configuration in which the power converter 20 includes five or more sub-bridge circuits 31 to 35, the power converter 20 may operate such that the first sub-bridge circuit 31 receives the rated power P0, and the second to n^{th} sub-bridge circuits transmit the rated power P0. Here, n denotes the number of operating sub-bridge circuits and is an integer of five or more.

In the above case, the power ratio, which is the ratio of the received power of the power receiving circuit to the received power of the main bridge circuit 30, will be 1/(n−2). In this case, in order to suppress the power transferring operation by each sub-bridge circuit, when the number of operating sub-bridge circuits is five, the inductance ratio may be set to ⅓ or less, and when the number of operating sub-bridge circuits is six, the inductance ratio may be set to ¼ or less.

It is possible to determine the impedance of each of the connection paths 70 to 74 to have the inductance ratio L1/LT2 which is equal to or less than the power ratio, assuming that two or more of the sub-bridge circuits operate differently from the other sub-bridge circuits.

For example, in a configuration in which the power converter 20 includes seven sub-bridge circuits, it is assumed that the power converter 20 operates such that two of the sub-bridge circuits receive the rated power P0, and the remaining five sub-bridge circuits transmit the rated power P0. In this case, the power received by the power receiving circuit will be 2×P0, the power transmitted by the power transmission circuit will be 5×P0, and the difference power of 3× P0 between the transmitted power of the power transmission circuit and the received power of the power receiving circuit becomes the received power of the main bridge circuit 30. The power ratio is the ratio of the received power 2×P0 of the power receiving circuit to the received power 3×P0 of the main bridge circuit 30, that is, ⅔. Therefore, by determining the impedance of each of the connection paths 70 to 74 such that the inductance ratio L1/LT2 becomes equal to or less than the power ratio of ⅔, it is possible to suppress the power transferring operation in each sub-bridge circuit under the above-described operating condition.

In a configuration in which the power converter 20 includes seven sub-bridge circuits, in a case where two of the sub-bridge circuits transmit power at the rated power P0 and the remaining five sub-bridge circuits receive power at the rated power P0, the transmitted power of the power transmission circuit is 2×P0, the received power of the power receiving circuit is 5×P0, and the transmitted power of the main bridge circuit 30 is 3×P0. In this case, the power ratio is the ratio of the transmitted power 2×P0 of the power transmission circuit to the transmitted power 3×P0 of the main bridge circuit 30. In other words, the power ratio is the ratio of the lower one of the received power of the power receiving circuit and the transmitted power of the power transmission circuit, to the difference power between the transmitted power of the power transmission circuit and the received power of the power receiving circuit.

When each of the sub-bridge circuits 31 to 34 is required to deliver electrical power lower than the rated power, the impedance of each of the connection paths 70 to 74 may be determined to avoid or suppress the power transferring operation in each of the sub-bridge circuits 31 to 34.

For example, the power converter 20 may operate to have the first sub-bridge circuit 31 work to receive power P1, the second to fourth sub-bridge circuits 32 to 34 work to transmit power P2, and the main bridge circuit 30 work to receives a difference power of 3×P2-P1. Here, the powers P1 and P2 are smaller than the rated power P0. Assuming this situation, by defining the power ratio as P1/(3×P2−P1), it is sufficient to determine the impedance of each of the connection paths 70 to 74 such that the link inductance ratio, which is the ratio of the link inductance L12 of the main connection path 70 to the link inductance L21 of the first sub-connection path 71, becomes equal to or less than the power ratio.

Here, the link inductance Lij is an inductance having a positive correlation with the inductance of each corresponding one of the connection paths 70 to 74, and is an inductance having a relationship with the transmission power Pij transmitted from the i^{th} bridge circuit to the j^{th} bridge circuit, and with the phase difference θ between the i^{th} bridge circuit and the j^{th} bridge circuit, as expressed by the following equation e2.

$${P}_{ij} = \frac{{V}_{i} {V}_{j} \frac{{n}_{i}}{{n}_{j}}}{2 π {fL}_{ij}} θ ( 1 - \frac{θ}{π} ) \qquad e 2$$

where Vi and Vj denote DC voltages at the i^{th} and j^{th} bridge circuits, respectively, ni and nj denote the number of turns of the coils used with the i^{th} and j^{th} bridge circuits, respectively, and f denotes the switching frequency. The link inductance Lij is specifically an inductance expressed by the following equations e3 and e4.

$${L}_{ij} = ( {L}_{i} + {L}_{THi} ) \{ {LT}_{j} ( \frac{1}{{L}_{m}} + {\sum }_{n \neq i , j} \frac{1}{{LT}_{n}} ) + 1 \} \qquad e3$$

$${L}_{THi} = {( \frac{1}{{L}_{m}} + {\sum }_{n \neq i} \frac{1}{{LT}_{n}} )}^{- 1} \qquad e4$$

where Lm is a magnetizing inductance. The numbers of the bridge circuits may be determined arbitrarily. For example, the main bridge circuit 30 may be defined as the first, and the first, second, third, and fourth sub-bridge circuits 31, 32, 33, and 34 may be defined as the second, third, fourth, and fifth, respectively.

### OTHER EMBODIMENTS

Each of the above-described embodiments may be modified in the following ways.

Instead of use of the inductances, a resistance value of each of the connection paths 70 to 74 may be selected to develop an impedance of the main connection path 70 which is lower than that of a corresponding one of the sub-connection paths 71 to 74. The resistance value of each of the connection paths 70 to 74 may be determined, for example, by changing a wiring resistance of each of the connection paths 70 to 74 or by providing a resistor in a corresponding one of the connection paths 70 to 74.

The power converter 20 may, as illustrated in FIG. 10, include the capacitor 90 disposed in the main connection path 70. In this case, the main coil 60 and the capacitor 90 are connected in series with each other in the main connection path 70.

The structure in FIG. 10 enables the switching operation of the main bridge circuit 30 to be controlled as a function of a resonance frequency given by the capacitance and inductance of the main connection path 70 to reduce the reactance of the main connection path 70. It is, therefore, possible to accurately realize a state in which the impedance of the main connection path 70 is smaller than those of the sub-connection paths 71 to 74.

The main connection path 70 may have disposed therein an inductor which is an external passive device. In this case, the impedance of the main connection path 70 may be set lower than those of the sub-connection paths 71 to 74 by making the inductance of the inductor in the main connection path 70 smaller than those of the inductors 81 to 84 arranged in the sub-connection paths 71 to 74.

The impedance of the main connection path 70 does not necessarily have to be determined to be smaller than those of the sub-connection paths 71 to 74. The power transferring operation in each of the sub-bridge circuits 31 to 34 may be suppressed by causing the controller 40 to perform switching control so as to satisfy the first power receiving condition and the second power receiving condition, or to perform switching control of each of the bridge circuits 30 to 34 so as to satisfy the first power transmission condition and the second power transmission condition. This minimizes unnecessary power transfer in each of the sub-bridge circuits 31 to 34 and also eliminates a risk of flow of overcurrent in each of the sub-bridge circuits 31 to 34.

Each of the above-described switches may be an N-channel MOSFET (Metal Oxide Semiconductor Field Effect Transistor) instead of an IGBT.

The power converter 20 may include a half-bridge circuit instead of a full-bridge circuit as each of the bridge circuits 30 to 34.

Each of the batteries 11 to 14 is not limited to an in-vehicle battery, but may be, for example, a storage battery that stores generated power of a power generation device utilizing renewable energy such as a solar power generation device.

Instead of each of the batteries 11 to 14, an electric appliance or a power system provided in a building such as an apartment building or a commercial facility may be connected to each of the sub-bridge circuits 31 to 34.

The controllers or how to construct them referred to in this disclosure may be realized by a special purpose computer which is equipped with a processor and a memory and programmed to execute one or a plurality of tasks created by computer-executed programs or alternatively established by a special purpose computer equipped with a processor made of one or a plurality of hardware logical circuits. The controllers or operations thereof referred to in this disclosure may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium.

Unique structures derived by the above-described embodiments will be described below.

### First Structure

A power converter (20) comprises:
a transformer (50) which includes a plurality of coils (60 to 64) magnetically coupled with each other; and
bridge circuits (30 to 34) which are provided one for each of the coils and each of which works to switch a polarity of ac voltage applied to a corresponding one of the coils to achieve bidirectional transfer of power between the bridge circuits through the transformer.

One of the bridge circuits which has highest rated power among the bridge circuits is defined as a main bridge circuit. A circuit other than the main bridge circuit among the bridge circuits is defined as a sub-bridge circuit (31 to 34). A main connection path (70) is provided which connects the main bridge circuit and one of the coils which is used with the main bridge circuit. The main connection path has an impedance lower than that of a sub-connection path (71 to 74) which connects the sub-bridge circuit and a corresponding one of the coils.

### Second Structure

The power converter as set forth in the above-described first structure, wherein the sub-bridge circuit includes a plurality of sub-bridge circuits that are ones of the bridge circuits other than the main bridge circuit. At least one of the sub-bridge circuits which receives power from another of the sub-bridge circuits is defined as a power receiving circuit. At least one of the sub-bridge circuits which transmits power to another of the sub-bridge circuits is defined as a power transmission circuit. A controller is provided which works to perform switching control of the bridge circuits to meet a first power receiving condition and a second power receiving condition when a transmission power of the power transmission circuit is larger than a received power of the power receiving circuit, and the main bridge circuit serves as the power receiving circuit. The first power receiving condition is a condition in which a timing of switching to a positive polarity of voltage applied to one of the coils which is used with the main bridge circuit and a timing of switching to a positive polarity of voltage applied to one of the coils which is used with the power receiving circuit are delayed relative to a timing of switching to a positive polarity of voltage applied to one of the coils which is used with the power transmission circuit. The second power receiving condition is a condition in which a timing of switching to a positive polarity of voltage applied to one of the coils which is used with the main bridge circuit is set earlier than a timing of switching to a positive polarity of voltage applied to one of the coils which is used with the power receiving circuit.

### Third Structure

The power converter as set forth in the above-described second structure, wherein one of the sub-bridge circuits serves as the power receiving circuit, while remaining ones of the sub-bridge circuits serve as the power transmission circuit. A ratio of a transmission power of the main bridge to a rated power of the power receiving circuit when the power receiving circuit and the power transmission circuit operate at rated powers thereof is defined as a power ratio. The impedance of the main connection path and the impedance of each of the sub-connection paths are set as a function of the power ratio.

### Fourth Structure

A power converter (20) comprises a transformer (50) which includes three or more coils (60 to 64) magnetically coupled with each other, and bridge circuits (30 to 34) which are provided one for each of the coils and each of which works to switch a polarity of ac voltage applied to a corresponding one of the coils to achieve bidirectional transfer of power between the bridge circuits through the transformer. One of the bridge circuits which has highest rated power among the bridge circuits is defined as a main bridge circuit. Circuits other than the main bridge circuit among the bridge circuits are defined as sub-bridge circuits (31 to 34). At least one of the sub-bridge circuits which receives power from another of the sub-bridge circuits is defined as a power receiving circuit. At least one of the sub-bridge circuits which transmits power to another of the sub-bridge circuits is defined as a power transmission circuit. A controller (40) is provided which works to perform switching control of the bridge circuits to meet a first power receiving condition and a second power receiving condition when a transmission power of the power transmission circuit is larger than a received power of the power receiving circuit, and the main bridge circuit serves as the power receiving circuit. The first power receiving condition is a condition in which a timing of switching to a positive polarity of voltage applied to one of the coils which is used with the main bridge circuit and a timing of switching to a positive polarity of voltage applied to one of the coils which is used with the power receiving circuit are delayed relative to a timing of switching to a positive polarity of voltage applied to one of the coils which is used with the power transmission circuit. The second power receiving condition is a condition in which the timing of switching to the positive polarity of voltage applied to one of the coils which is used with the main bridge circuit is set earlier than the timing of switching to the positive polarity of voltage applied to one of the coils which is used with the power receiving circuit.

### Fifth Structure

The power converter as set forth in the above-described structure, wherein the sub-bridge circuit includes a plurality of sub-bridge circuits that are ones of the bridge circuits other than the main bridge circuit. At least one of the sub-bridge circuits which receives power from another of the sub-bridge circuits is defined as a power receiving circuit. At least one of the sub-bridge circuits which transmits power to another of the sub-bridge circuits is defined as a power transmission circuit. A controller is provided which works to perform switching control of the bridge circuits to meet a first power transmission condition and a second power transmission condition when a received power of the power receiving circuit is larger than a transmission power of the power transmission circuit, and the main bridge circuit serves as the power transmission circuit. The first power transmission condition is a condition in which a timing of switching to a positive polarity of voltage applied to one of the coils which is used with the main bridge circuit and a timing of switching to a positive polarity of voltage applied to one of the coils which is used with the power transmission circuit are advanced relative to a timing of switching to a positive polarity of voltage applied to one of the coils which is used with the power receiving circuit. The second power transmission condition is a condition in which the timing of switching to the positive polarity of voltage applied to one of the coils which is used with the main bridge circuit is set after the timing at which voltage applied to one of the coils which is used with the power transmission circuit is switched to the positive polarity.

### Sixth Structure

The power converter as set forth in the above-described fifth structure, wherein one of the sub-bridge circuits serves as the power transmission circuit, while remaining ones of the sub-bridge circuits serve as the power receiving circuit. A ratio of a rated power of the power transmission circuit to a transmission power of the main bridge when the power receiving circuit and the power transmission circuit operate at rated powers thereof is defined as a power ratio. An impedance of the main connection path and an impedance of each of the sub-connection paths are set as a function of the power ratio.

### Seventh Structure

A power converter (20) comprises a transformer (50) which includes three or more coils (60 to 64) magnetically coupled with each other, and bridge circuits (30 to 34) which are provided one for each of the coils and each of which works to switch a polarity of ac voltage applied to a corresponding one of the coils to achieve bidirectional transfer of power between the bridge circuits through the transformer. One of the bridge circuits which has the highest rated power among the bridge circuits is defined as a main bridge circuit (30). Circuits other than the main bridge circuit among the bridge circuits are defined as sub-bridge circuits (31 to 34). At least one of the sub-bridge circuits which receives power from another of the sub-bridge circuits is defined as a power receiving circuit. At least one of the sub-bridge circuits which transmits power to another of the sub-bridge circuits is defined as a power transmission circuit. A controller is provided which works to perform switching control of the bridge circuits to meet a first power transmission condition and a second power transmission condition when a received power of the power receiving circuit is larger than a transmission power of the power transmission circuit, and the main bridge circuit serves as the power transmission circuit. The first power transmission condition is a condition in which a timing of switching to a positive polarity of voltage applied to one of the coils which is used with the main bridge circuit and a timing of switching to a positive polarity of voltage applied to one of the coils which is used with the power transmission circuit are advanced relative to a timing of switching to a positive polarity of voltage applied to one of the coils which is used with the power receiving circuit, The second power transmission condition is a condition in which the timing of switching to the positive polarity of voltage applied to one of the coils which is used with the main bridge circuit is set after the timing at which voltage applied to one of the coils which is used with the power transmission circuit is switched to the positive polarity.

### Eighth Structure

The power converter as set forth in any one of the above-described first to third, fifth, and sixth structures, wherein each of the sub-connection paths has an inductor (81 to 84) disposed therein, and the main connection path has no inductor disposed therein.

### Ninth Structure

The power converter as set forth in any one of the above-described first to third, fifth, and sixth structures, wherein the main connection path has a capacitor (90) arranged therein.

### Tenth Structure

The power converter as set forth any one of the above-described first to ninth structure, wherein a power system (10) is connectable to the main bridge circuit. Chargeable and dischargeable energy storage units (11-14) are connectable to the sub-bridge circuits. Bidirectional transfer of power is performed between the power system and each of the energy storage units.

This disclosure is not limited to the above embodiments, but may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure.

1. A power converter comprising:
a transformer which includes a plurality of coils magnetically coupled with each other; and
bridge circuits which are provided one for each of the coils and each of which works to switch a polarity of ac voltage applied to a corresponding one of the coils to achieve bidirectional transfer of power between the bridge circuits through the transformer, wherein
one of the bridge circuits which has highest rated power among the bridge circuits is defined as a main bridge circuit,
a circuit other than the main bridge circuit among the bridge circuits is defined as a sub-bridge circuit,
a main connection path is provided which connects the main bridge circuit and one of the coils which is used with the main bridge circuit, the main connection path having an impedance lower than that of a sub-connection path which connects the sub-bridge circuit and a corresponding one of the coils.

2. The power converter as set forth in claim 1, wherein the sub-bridge circuit includes a plurality of sub-bridge circuits that are ones of the bridge circuits other than the main bridge circuit,
at least one of the sub-bridge circuits which receives power from another of the sub-bridge circuits is defined as a power receiving circuit,
at least one of the sub-bridge circuits which transmits power to another of the sub-bridge circuits is defined as a power transmission circuit,
a controller is provided which works to perform switching control of the bridge circuits to meet a first power receiving condition and a second power receiving condition when a transmission power of the power transmission circuit is larger than a received power of the power receiving circuit, and the main bridge circuit serves as the power receiving circuit,
the first power receiving condition is a condition in which a timing of switching to a positive polarity of voltage applied to one of the coils which is used with the main bridge circuit and a timing of switching to a positive polarity of voltage applied to one of the coils which is used with the power receiving circuit are delayed relative to a timing of switching to a positive polarity of voltage applied to one of the coils which is used with the power transmission circuit, and
the second power receiving condition is a condition in which the timing of switching to the positive polarity of voltage applied to one of the coils which is used with the main bridge circuit is set earlier than the timing of switching to the positive polarity of voltage applied to one of the coils which is used with the power receiving circuit.

3. The power converter as set forth in claim 2, wherein one of the sub-bridge circuits serves as the power receiving circuit, while remaining ones of the sub-bridge circuits serve as the power transmission circuit,
a ratio of a transmission power of the main bridge to a rated power of the power receiving circuit when the power receiving circuit and the power transmission circuit operate at rated powers thereof is defined as a power ratio, and
the impedance of the main connection path and the impedance of each of the sub-connection paths are set as a function of the power ratio.

4. A power converter comprising:
a transformer which includes three or more coils magnetically coupled with each other; and
bridge circuits which are provided one for each of the coils and each of which works to switch a polarity of ac voltage applied to a corresponding one of the coils to achieve bidirectional transfer of power between the bridge circuits through the transformer, wherein
one of the bridge circuits which has highest rated power among the bridge circuits is defined as a main bridge circuit,
circuits other than the main bridge circuit among the bridge circuits are defined as sub-bridge circuits,
at least one of the sub-bridge circuits which receives power from another of the sub-bridge circuits is defined as a power receiving circuit,
at least one of the sub-bridge circuits which transmits power to another of the sub-bridge circuits is defined as a power transmission circuit,
a controller is provided which works to perform switching control of the bridge circuits to meet a first power receiving condition and a second power receiving condition when a transmission power of the power transmission circuit is larger than a received power of the power receiving circuit, and the main bridge circuit serves as the power receiving circuit,
the first power receiving condition is a condition in which a timing of switching to a positive polarity of voltage applied to one of the coils which is used with the main bridge circuit and a timing of switching to a positive polarity of voltage applied to one of the coils which is used with the power receiving circuit are delayed relative to a timing of switching to a positive polarity of voltage applied to one of the coils which is used with the power transmission circuit, and
the second power receiving condition is a condition in which the timing of switching to the positive polarity of voltage applied to one of the coils which is used with the main bridge circuit is set earlier than the timing of switching to the positive polarity of voltage applied to one of the coils which is used with the power receiving circuit.

5. The power converter as set forth in claim 1, wherein the sub-bridge circuit includes a plurality of sub-bridge circuits that are ones of the bridge circuits other than the main bridge circuit,
at least one of the sub-bridge circuits which receives power from another of the sub-bridge circuits is defined as a power receiving circuit,
at least one of the sub-bridge circuits which transmits power to another of the sub-bridge circuits is defined as a power transmission circuit,
a controller is provided which works to perform switching control of the bridge circuits to meet a first power transmission condition and a second power transmission condition when a received power of the power receiving circuit is larger than a transmission power of the power transmission circuit, and the main bridge circuit serves as the power transmission circuit,
the first power transmission condition is a condition in which a timing of switching to a positive polarity of voltage applied to one of the coils which is used with the main bridge circuit and a timing of switching to a positive polarity of voltage applied to one of the coils which is used with the power transmission circuit are advanced relative to a timing of switching to a positive polarity of voltage applied to one of the coils which is used with the power receiving circuit, and
the second power transmission condition is a condition in which the timing of switching to the positive polarity of voltage applied to one of the coils which is used with the main bridge circuit is set after the timing at which voltage applied to one of the coils which is used with the power transmission circuit is switched to the positive polarity.

6. The power converter as set forth in claim 5, wherein one of the sub-bridge circuits serves as the power transmission circuit, while remaining ones of the sub-bridge circuits serve as the power receiving circuit,
a ratio of a rated power of the power transmission circuit to a transmission power of the main bridge when the power receiving circuit and the power transmission circuit operate at rated powers thereof is defined as a power ratio, and
an impedance of the main connection path and an impedance of each of the sub-connection paths are set as a function of the power ratio.

7. A power converter comprising:
a transformer which includes three or more coils magnetically coupled with each other; and
bridge circuits which are provided one for each of the coils and each of which works to switch a polarity of ac voltage applied to a corresponding one of the coils to achieve bidirectional transfer of power between the bridge circuits through the transformer, wherein
one of the bridge circuits which has highest rated power among the bridge circuits is defined as a main bridge circuit,
circuits other than the main bridge circuit among the bridge circuits are defined as sub-bridge circuits,
at least one of the sub-bridge circuits which receives power from another of the sub-bridge circuits is defined as a power receiving circuit,
at least one of the sub-bridge circuits which transmits power to another of the sub-bridge circuits is defined as a power transmission circuit,
a controller is provided which works to perform switching control of the bridge circuits to meet a first power transmission condition and a second power transmission condition when a received power of the power receiving circuit is larger than a transmission power of the power transmission circuit, and the main bridge circuit serves as the power transmission circuit,
the first power transmission condition is a condition in which a timing of switching to a positive polarity of voltage applied to one of the coils which is used with the main bridge circuit and a timing of switching to a positive polarity of voltage applied to one of the coils which is used with the power transmission circuit are advanced relative to a timing of switching to a positive polarity of voltage applied to one of the coils which is used with the power receiving circuit, and
the second power transmission condition is a condition in which the timing of switching to the positive polarity of voltage applied to one of the coils which is used with the main bridge circuit is set after the timing at which voltage applied to one of the coils which is used with the power transmission circuit is switched to the positive polarity.

8. The power converter as set forth in claim 1, wherein each of the sub-connection paths has an inductor disposed therein,
the main connection path has no inductor disposed therein.

9. The power converter as set forth in claim 1, wherein the main connection path has a capacitor arranged therein.

10. The power converter as set forth in claim 1, wherein a power system is connectable to the main bridge circuit,
chargeable and dischargeable energy storage units are connectable to the sub-bridge circuits, and
bidirectional transfer of power is performed between the power system and each of the energy storage units.

11. The power converter as set forth in claim 2, wherein each of the sub-connection paths has an inductor disposed therein,
the main connection path has no inductor disposed therein.

12. The power converter as set forth in claim 3, wherein each of the sub-connection paths has an inductor disposed therein,
the main connection path has no inductor disposed therein.

13. The power converter as set forth in claim 5, wherein each of the sub-connection paths has an inductor disposed therein,
the main connection path has no inductor disposed therein.

14. The power converter as set forth in claim 6, wherein each of the sub-connection paths has an inductor disposed therein,
the main connection path has no inductor disposed therein.

15. The power converter as set forth in claim 2, wherein the main connection path has a capacitor arranged therein.

16. The power converter as set forth in claim 3, wherein the main connection path has a capacitor arranged therein.

17. The power converter as set forth in claim 5, wherein the main connection path has a capacitor arranged therein.

18. The power converter as set forth in claim 6, wherein the main connection path has a capacitor arranged therein.
